(19) United States
(12) Patent Application Publication
(10) Pub. No.: US 2011/0167844 A1
(43) Pub. Date: Jul. 14, 2011

(54) Defrost Vapor Recondenser

(76) Inventor: Sean Edward Drury, Chisago City, MN (US)

(21) Appl. No.: 12/684,274

(22) Filed: Jan. 8, 2010

(51) Int. Cl. F25D 21/06; F25D 17/06; F25B 49/00; F25D 21/00; C09K 5/04

(52) U.S. Cl. 62/80; 62/426; 62/176.1; 62/285; 252/67

(57) ABSTRACT

In general terms, this disclosure is directed towards a vapor recovery system. The vapor recovery system comprises material specifically designed to recondense vapor during defrost cycle. This material would be of sufficient thermal mass to remain at a lower temperature during the defrost cycle. The vapor may be condensed directly in the evaporator compartment or indirectly by removing the vapor to a remotely located recondense medium.

The vapor recovery system may comprise of at least one vapor tube, a fan, and a vapor recondenser. The vapor collection tube is located proximate an evaporator. The fan is in fluid communication with the vapor collection tube and the vapor recondenser.

### FIELD OF DISCLOSURE

The present disclosure relates to refrigeration systems. More specifically, the present disclosure relates to system methods for extracting defrost vapor during a defrost cycle.

### BACKGROUND

During operation of a refrigeration system condensation forms on the evaporator. As this condensation forms, it begins to freeze forming ice and frost that can cause evaporator blockage. Refrigeration systems used in refrigerators, freezers and other climate controlled settings commonly utilize a defrost cycle to remove ice and frost from the evaporator. During the defrost cycle heat is applied to the evaporator to thaw any ice that may have formed on the evaporator. The heat, as measured in BTU's per hour or Watts, applied to the evaporator during the defrost cycle is usually greater than the energy required to remove heat during the refrigeration cycle by a factor of 2.5 to 3. For example, it the refrigeration system can extract 500 BTU's/HR of heat from a conditioned space, during the defrost cycle 1,250 to 1500 BTU's/HR of heat may be added to the evaporator. This additional energy (heat) reduces the defrost time thereby minimizing the refrigeration system's down time.

During the defrost cycle, a part of the ice and frost formed during the refrigeration cycle operation changes from a solid to a liquid. This liquid then falls to a drain pan that is proximate the evaporator and discarded via a drain line. Another part of the ice and frost changes from a solid to a vapor. The warm vapor moves up and away from the evaporator via natural convection. The vapor may be close to the dew point temperature. For example, the vapor may be within five degrees of the dew point. As the vapor moves to and contacts colder surfaces of the refrigerated space, it condenses from a vapor to a liquid. The condensed vapor forms ice and frost on surfaces in the refrigeration system components to be removed during the next defrost cycle.

### SUMMARY

In general terms, this disclosure is directed towards a vapor recovery system. The vapor recondenser may be integral to the evaporator compartment. A recondenser material with high latent heat characteristics such as phase change material to recondense vapor may be located directly to the evaporator compartment. The vapor recovery system may also comprise at least one vapor collection tube and a fan for vapor removal to a vapor condenser medium. The vapor collection tube is located proximate an evaporator. The fan is in fluid communication with the vapor collection tube and the vapor recondenser.

It is to be understood that both the foregoing general description and the following detailed description, are examples and explanatory only and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 depicts an operating environment; and

FIG. 2 depicts a defrost vapor recondenser system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

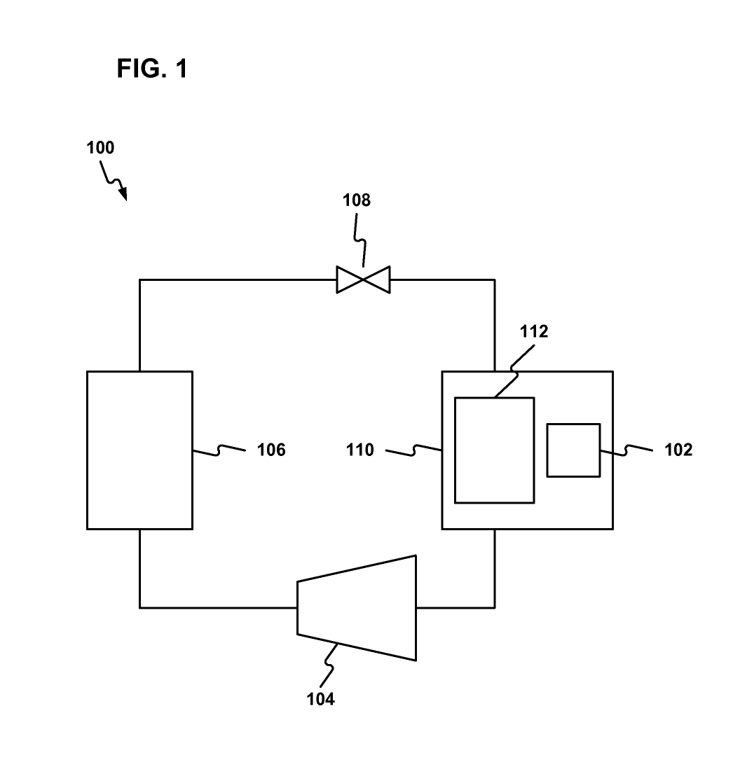

Turning now to figures, FIG. 1 describes an operating environment for a defrost vapor recondenser 102 and refrigeration system 100. The refrigeration system 100 includes a compressor 104, a condenser 106, a throttling device 108 and an evaporator 112. Evaporator 112 is located in a conditioned space 110. Conditioned space 110 also a defrost vapor recondenser 102. During operation of refrigeration cycle 100, compressor 104 compresses a vapor refrigerant to a super heated state, which then enters into condenser 106. While in condenser 106 the super heated vapor condenses to a saturated mixture, generally comprised of a liquid-vapor mixture. This liquid-vapor mixture exits condenser 106 and passes throttled device 108 where its temperature and pressure are reduced causing it to become a sub-cooled liquid. Sub-cooled liquid existing throttling device 108 then enters conditioned space 110 and evaporator 112. As the sub-cooled liquid flows through evaporator 112, air from within conditioned space 110 is passed over evaporator 112 causing heat transfer from within air in conditioned space 110 to the refrigerant flowing through evaporator 112. The refrigerant boils to become a superheated vapor where it returns to compressor 104 and the cycle starts again.

As refrigerant system 100 is operating, moisture contained within the air located inside conditioned space 110 condenses on evaporator 112. Over time this condensation freezes to form ice crystals and/or sheets of ice. Generally, the controllers for refrigeration cycles, have programs which cause the defrost cycle to run. During the defrost cycle, heat is applied to the evaporator to melt away any ice or frost that may have formed on evaporator 112. As this ice and frost melt, some of this liquid exits a drain pan (not shown) and exits the conditioned space 110. However, some of the liquid formed by the melting of the ice and frost vaporizes and rises to the top of the conditioned space 110 and condenses either on surfaces and/or contents located within conditioned space 110. Defrost vapor recondenser 102 extracts a substantial portion of any vapors generated by the defrost cycle.

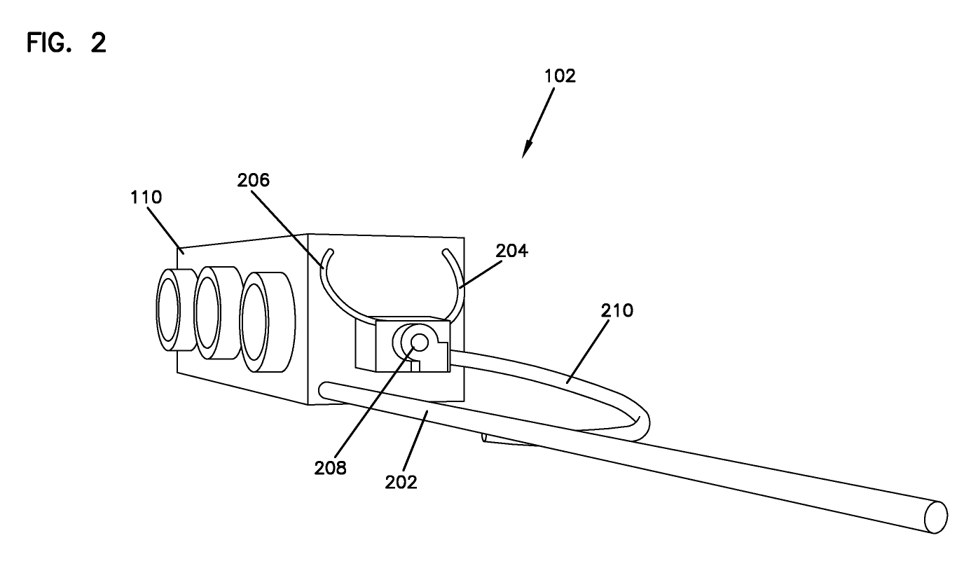

Turning now to FIG. 2, FIG. 2 depicts defrost vapor recondenser 102. As shown in FIG. 2, defrost vapor recondenser 102 comprises a drain line 202, vapor intake lines 204 and 206, a fan 208, and a recondenser outlet 210. In various embodiments, vapor intake lines 204 and 206 are located at the top of evaporator 112.

Drain line 202 removes liquid formed by melting ice during the defrost cycle that collects in a drain pan. To remove vapor produced by the defrost cycle, vapor intake lines 204 and 206 are located proximate the evaporator 112. Vapor intake lines 204 and 206 may be perforated to allow for collection of vapor along a predefined section of vapor intake lines 204 and 206.

Vapor intake lines 204 and 206 are connected to fan 208. Fan 208 may be a cryogenic axial fan unit. During operation, fan 208 causes a negative pressure inside refrigerated space 110 thereby causing vapor formed during the defrost cycle to be extracted via vapor intake lines 204 and 206. Fan 208 and heaters located in and/or proximate recondenser outlet 210 can comprise an adjustable time delay relay that is energized by the defrost cycle controller. Fan 208 may also be variable to minimize air movement to what is necessary to collect vapor.

Vapor intake lines 204 and 206 may be in proximity with the length of the front and rear of evaporator 112. Each duct may have holes facing evaporator 112 for vapor to enter. The vapor is removed through a pressure difference created by fan 208. The defrost vapor is captured as it rises to vapor intake lines 204 and 206 during the defrost cycle. Vapor intake lines 204 and 206 may also have an internal heat source to prevent ice formation and enhance vapor transport.

As the vapor is extracted through fan 208, it enters recondenser outlet 210. The vapor condenses after contact with the colder water at the bottom of the drain line or contacts the drain line, which is at a temperature below the vapor's dew point. Recondenser outlet 210 then proceeds to a drain pan or other disposing means for removing condensation. Recondenser outlet 210 may also include a freeze protection device (not shown). The freeze protection device may be a simple 4-6 Watt heater configured to keep the condensation from freezing inside recondenser outlet 210.

Defrost vapor recondenser can be controlled by the refrigeration system 100's defrost cycle. For example, when the defrost cycle is initiated, defrost vapor recondenser 102 can also be activated. One skilled in the art will readily be able to configure defrost vapor recondenser 102 to active when the defrost cycle activates.

Once the defrost cycle is running, water vapor can be detected via a sensor (not shown). The sensors may be humidity sensors and/or optical sensors. Once water vapor has been detected and/or the defrost cycle has been initiated, the defrost vapor recondenser 102 can be initialized. Once defrost vapor recondenser 102 has been initialized, water vapor from refrigerator space 110 may be extracted via vapor intake lines 204 and 206. After the water vapor enters vapor intake lines 204 and 206 it passes through fan 208 and enters recondenser outlet 210. While in recondenser outlet 210, the water vapor is recondensed and disposed of by directing the now condensed water vapor to a drain pan or otherwise dispose of.

As the liquid is being disposed, a controller operating refrigeration system 100, defrost vapor recondenser 102, and the defrost cycle monitors refrigeration system 100, the defrost cycle and/or sensor determine an appropriate to terminate operation of defrost vapor recondenser 102. For example, if: i) the defrost cycle has ended, ii) the sensor indicates the humidity in refrigerated space 110 is below a preset level, and/or iii) refrigeration system 100 begins operating, the controller will stop defrost vapor recondenser 102 from operating.

During defrost vapor recondenser 102 operation, a time delay or electric eye may be wired in series to the centrifugal fan motor to assure fan operation and/or only during the times vapor is present and/or proximate evaporator 112.

The various embodiments described above are provided by the way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. Material specifically designed to recondense vapor during defrost cycle. This material would be of sufficient thermal mass to remain at a lower temperature during the defrost cycle. The vapor may be condensed directly in the evaporator compartment or indirectly by removing the vapor to a remotely located recondense medium.

2. A vapor recovery system may comprise of:
At least one vapor collection tube located proximate an evaporator;
A fan in fluid communication with at least one vapor collection tube; and
A vapor recondenser in fluid communication with the fan.

3. The vapor recovery system of claim 1, wherein at least one vapor collection tube may comprise perforations.

4. The vapor recovery system of claim 1, further comprising a heat source proximate the vapor recondenser.

5. The vapor recovery system of claim 1, further comprising a sensor in electrical communication with a controller and the fan.

6. The vapor recovery system of claim 4, wherein the sensor is a humidity sensor.

7. The vapor recovery system of claim 4, wherein the sensor is an optical sensor.

8. A method for defrost vapor recondensing comprising:
Collecting defrost vapor from a refrigerated space;
Recondensing the defrost vapor in a recondensor outlet; and
Extracting defrost vapor from a refrigerated space.

9. The method of claim 7, further comprising heating the recondenser outlet to a temperature above a vapor dew point.

10. The method of claim 7, wherein collecting the defrost vapor from the refrigerated space comprises collecting the defrost vapor from a top portion of the refrigerated space.

11. The method of claim 7, wherein collecting the defrost vapor from the refrigerated space comprises collecting the defrost vapor via at least one vapor collection tube having perforations.
